(19) United States
(12) Patent Application Publication
(10) Pub. No.: US 2012/0102189 A1
(43) Pub. Date: Apr. 26, 2012

(54) DYNAMIC HETEROGENEOUS COMPUTER NETWORK MANAGEMENT TOOL

(76) Inventors: Stephany Burge, Moscow, ID (US); Ronald S. Cok, Rochester, NY (US); Mutsubu Inayama, Albany, CA (US); Lee Tucker, San Francisco, CA (US); Laurent Valadares, Berkeley, CA (US); Jeff Younker, Oakland, CA (US)

(21) Appl. No.: 12/910,902

(22) Filed: Oct. 25, 2010

(51) Int. Cl. G06F 15/173

(52) U.S. Cl. 709/224

(57) ABSTRACT

Method and apparatus for managing a network includes assigning a plurality of processors to a plurality of network connected computing groups, wherein each processor in an assigned computing group receives task types over the network that are different from task types received over the network by processors assigned to any other computing group. A network monitor detects a workload of each of the computing groups and sets an upper threshold and a lower threshold for each of the plurality of computing groups. If it detects that a workload of a computing group is equal to or higher than its set upper threshold and that a workload of another computing groups is equal to or lower than its set lower threshold, it will initiate a reassignment procedure for reassigning a processor from the lower workload computing group to the higher workload computing group.

### FIELD OF THE INVENTION

The present invention relates to a computer network and tools for managing the computer network.

### BACKGROUND OF THE INVENTION

Networks of computers are widely used. Such networks typically include multiple computers connected to a common communication network. Individuals each use one of the computers to perform work and to interact with other users that are themselves working with other computers on the computer communication network. In this case, users perform tasks on different computers and typically do not employ other computer resources in the performance of each of the tasks. Sometimes the tasks are performed remotely, that is, a user at one computer instructs a remote computer connected to the same communication network to remotely perform tasks.

In other computer networks, a single task is broken down into separate related tasks, each task assigned to a different computer. A controlling computer allocates tasks to the computers on the network and receives results from those computers which are then integrated into a common, combined result. A modular computer system is described in U.S. Patent Application 20030051167 that includes a switch for distributing information signals. Providing servers for supporting access to internet web pages is also known. U.S. Pat. No. 7,680,848 describes network-connected multi-processor servers that handle multiple asynchronous user requests. Automating the configuration of network-connected computers is also known. For example, U.S. Pat. No. 7,673,175 describes tracking the configuration of a system and restoring a desired state.

The above methods do not address the need for real-time management of heterogeneous computer networks addressing a common computing task that requires a variety of different software application tools.

### SUMMARY OF THE INVENTION

In accordance with one preferred embodiment of the present invention, a network comprises a plurality of processors each assigned to one of a plurality of computing groups. A network monitor detects a workload of each of the plurality of computing groups. A network controller responds to the network monitor by reassigning a processor from a first computing group that is detected by the monitor to be performing below a first preselected threshold to a second computing group that is detected by the monitor to be performing above a second preselected threshold. Because the computing groups are logically separated according to task types, the reassigned processor processes tasks in the second computing group that are of a different type than the tasks performed by the processor when it was in the first computing group. A network controller transmits a notification over the network to a managing node or nodes, in response to detecting that the second computing group is performing above the second preselected threshold. The network monitor is capable of detecting various performance characteristic of the processors including an inoperable state, an unknown state, an in-service state, and a percent utilization state. The first and second preselected thresholds can include a percent utilization rate, a rate of images communicated in the network, or other measures. A database identifies software applications associated with particular ones of the computing groups wherein the software applications are executable only by a processor in an associated computing group. Computer hardware types associated with each of the software applications are also identified in the database. Processor reassignment entails at least a soft shut down of a reassigned processor which entails a procedure wherein new tasks are not assigned to the processor undergoing reassignment until it reaches an idle state. Network attributes are also stored in the database that specify allowable interactions of the software applications between processors in any of the computing groups.

Another preferred embodiment of the present invention comprises a method of managing a network. The method includes the steps of assigning a plurality of processors to a plurality of network connected computing groups, wherein each processor in an assigned computing group receives task types over the network that are different from task types received over the network by processors assigned to any other computing group. A network monitor detects a workload of each of the computing groups and sets an upper threshold and a lower threshold for each of the plurality of computing groups. If it detects that a workload of a computing group is equal to or higher than its set upper threshold and that a workload of another computing groups is equal to or lower than its set lower threshold, it will initiate a reassignment procedure for reassigning a processor from the lower workload computing group to the higher workload computing group. A notification is transmitted over the network to a managing node or nodes, or to a node or nodes that otherwise are programmed to receive such notifications. Performance characteristics that are detectable include inoperable states, an unknown state, an in-service state, a percent utilization state, or a rate of images, i.e. number of images per unit time, communicated in the network. Software applications and hardware types of processors' processing systems associated with computing groups are also stored in the database. A shut down procedure for the processor being reassigned is undertaken and includes cutting off new task assignments for the processor being reassigned until it is idled.

In accordance with one preferred embodiment of the present invention, a tool for managing a heterogeneous computer network includes a plurality of computers logically organized into groups wherein each of the computers includes a hardware type, a corresponding a computer identifier, and one or more computer hardware attributes. One of the groups includes computers having computer hardware attributes and computer hardware types different from computers in a second group. Software applications have a software identifier and execute on the computers in one of the groups. Software applications also have a software attribute that specifies allowable software interactions with other software applications executing on computers within the same group, and with software applications executing on computers in a different group. A database stores the computer hardware attributes, types, and identifiers, the software attributes, rules specifying combinations of the computer hardware attributes and the software attributes, computer identifiers of computers within a group, and software identifiers of the software applications currently executing.

A metatool automatically detects computers connected to the network and the type of each of the computers. The tool automatically modifies the database in response to changes in which computers are currently connected to the network while at least some of the computers currently connected to the network are executing one of the software applications. The metatool loads the computer hardware attributes from the database into corresponding computers connected to the network, loads the software attributes from the database into the software applications executing on the computers, assigns at least one of the software applications to corresponding ones of the computers, and assigns at least one of the computers to a group. The metatool also monitors and stores network capacity and an operating-computer performance of the network.

The present invention has the advantage that a single tool provides real-time support and management of networks of heterogeneous computers addressing a common computing task requiring a variety of different software application tools, thereby substantially decreasing the effort and cost to maintain and operate the heterogeneous system and providing greatly increased robustness and reduced errors.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate preferred embodiments whose elements are not interchangeable. In fact, many of the elements described as related to a particular preferred embodiment can be used together with, and possibly interchanged with, elements of other described preferred embodiments. Many changes and modifications may be made within the scope of the present invention without departing from the spirit thereof, and the invention includes all such modifications. The figures below are intended to be drawn neither to any precise scale with respect to relative size, angular relationship, or relative position, nor to any combinational relationship with respect to interchangeability, substitution, or representation of an actual implementation.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a schematic illustration of a system incorporating a tool in accordance with a preferred embodiment of the present invention;

FIG. 2 is a tabular illustration of a database useful with a preferred embodiment of the present invention; and

FIG. 3 is a schematic illustration of a tool in accordance with a preferred embodiment of the present invention; and

FIG. 4 is a schematic illustration of an alternative organization of the system incorporating the tool illustrated in FIG. 1; and

FIG. 5 is a tabular illustration of the database of FIG. 2 with a reassigned computer;

FIG. 6 is a tabular illustration of the database of FIG. 2 with a reassigned computer;

FIG. 7 is a tabular illustration of the database of FIG. 2 with an additional computer;

FIG. 8 is a flow diagram illustrating the initialization and operation of a system according to a preferred embodiment of the present invention;

FIG. 9 is a flow diagram illustrating a modification to a system according to a preferred embodiment of the present invention;

FIG. 10 is a flow diagram illustrating an adaptation and re-configuration of a system according to a preferred embodiment of the present invention; and

FIGS. 11A-C are schematic illustrations of a system with computers divided into groups according to a preferred embodiment of the present invention.

### DETAILED DESCRIPTION OF THE INVENTION

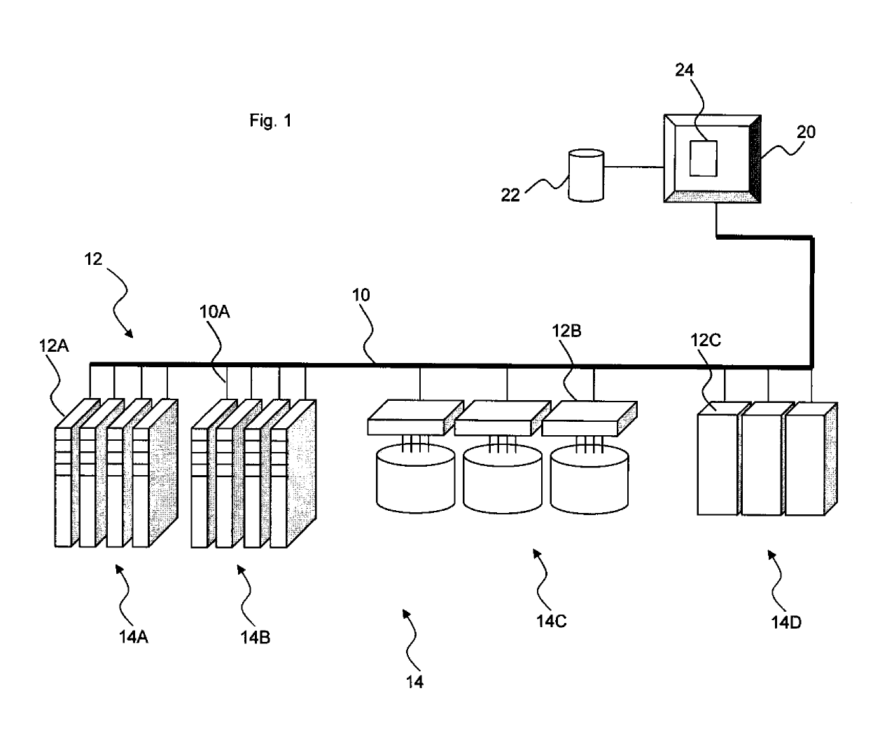

Referring to FIG. 1, a tool for managing a heterogeneous computer network comprises a computer network 10, a plurality of computers 12, each computer executing one or more software applications, a database 22 coupled to the network, and a tool 20. The computers are logically organized into groups 14 wherein each group 14 includes one or more of the plurality of computers 12. Each of the plurality of computers 12 has a hardware type and a corresponding computer identifier, and one or more computer hardware attributes, wherein a first one of the groups includes computers 12 having computer hardware attributes and computer hardware types different from computers in a second one of the groups.

Each of the software applications has a software identifier and executes on computers of one of the groups 14. Each of the software applications has one or more software attributes that specify allowable software interactions with other software applications;

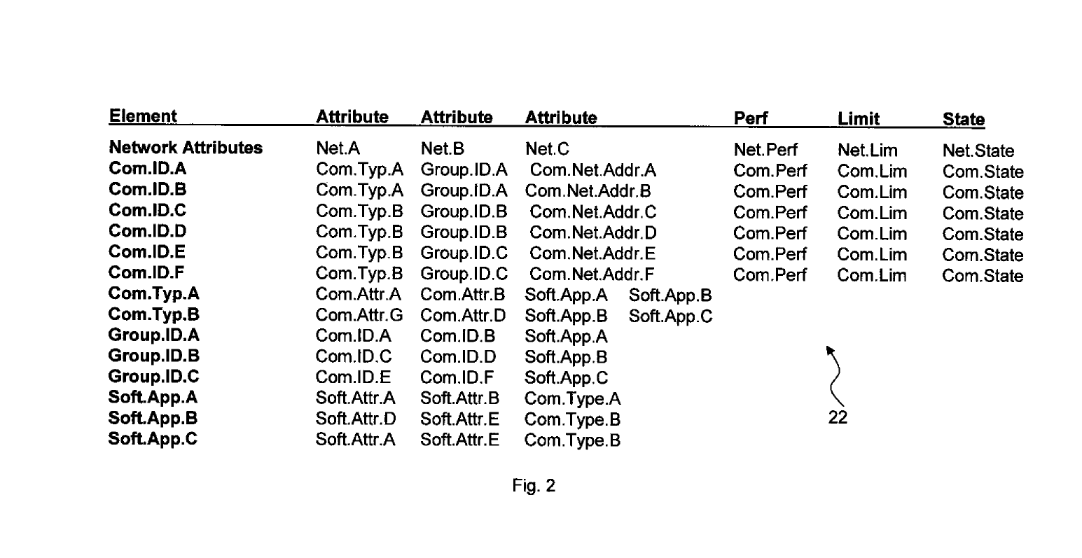

The database 22 stores the computer identifiers, the hardware types, and the computer hardware attributes of each of the plurality of computers 12, the software attributes of each of the software applications, rules specifying which of the plurality of software applications are allowed to run on which of the plurality of computers based on the software attributes, the computer hardware attributes and the software attributes on identified ones of the plurality of computers, and stores the computer identifiers of computers within a group 14, and the software identifiers of the software applications currently executing on the plurality of computers 12. The database 22 is stored in a computer-accessible storage medium such as a hard drive and is accessible by a computer executing a program that implements the tool 20. The tool interacts with the database in response to user commands. An example of some of the data is illustrated in FIG. 2 and data stored in the database is described below. The data is either input by a user (e.g. system manager) specifying the desired attributes of the desired system elements (computers, storage devices, and network) or is obtained by monitoring and recording the performance of the system elements (e.g. by the tool software). The rules specifying the combinations of computer hardware attributes and software attributes include the computer hardware types and a list of software applications associated with each of the computer hardware types and include the software identifiers and a list of computer hardware types associated with each of the software identifiers (e.g. as shown in FIG. 2). The rules are determined by the desired capabilities of the system elements and limited by the hardware performance of the elements employed in the system. The rules enable operating changes in the system without causing the system to cease functioning and reduce the amount of user-interactive specification and configuration necessary to modify the system or respond to faults or operational changes. The rules are activated by either an operator instruction (for example to add or modify a system element) or in response to system performance changes that fall outside a pre-determined acceptable limit. Such limits can also be stored in the database. For example, if a computer server ceases functioning, any tasks allocated to that computer server can be reallocated to another computer server or servers. Rules include authentication and authorization for specific functions within groups, for example, password authentication or for access to specific computers, consistency between operating systems and software releases, and specify which computers execute which software tools. For example, a computer designed and licensed for e-commerce application cannot necessarily run on another computer designed for image processing. This can be enforced in the system by listing applications associated with computer types, as shown in FIG. 2, where computer types are associated with computer attributes (e.g. operating system, hardware attributes) and software applications. The database stores the attributes of the various elements in the system, as well as the task assignments, status, and interaction specifications. The database is stored within a single file on a single storage medium or divided among two or more files on one or more storage media.

A tool 20 with an operator-interactive user interface 24 automatically detects computers 12 connected to the network 10, their identifiers, a type of each of said plurality of computers 12 connected to the network 10, and the computer attributes and automatically modifies the database 22 in response to changes in which computers 12 are currently connected to the network 10 while at least some of the computers 12 currently connected to the network 10 are executing one of the software applications. The database 22 modifications are made while the computers are operational and executing a software application. This can be accomplished by polling the active computers, for example by a network manager or the computer on which the tool executes. The detected computers respond to the poll by providing requested information that is then analyzed or stored in the database by the tool. Alternatively, the computers can send signals to a computer such as a network manager.

The database can then include a list of the computers and their attributes, as shown in FIG. 2. The tool can analyze the computer attributes for consistency with the database rules. If an inconsistency is detected, the tool can correct the problem by modifying the configuration of the computer that has the error or by notifying an operator. When a new computer is detected and its attributes are stored in the database, the tool can provide the appropriate configuration information derived from the database, for example by loading the appropriate hardware and hardware attribute configurations and software and software attributes as listed in FIG. 2. The new or corrected computers can then be put into service. The tool also loads the computer hardware attributes from the database into corresponding computers 12A, 12B, 12C connected to the network 10, loads the software attributes from the database 22 into the software applications executing on the computers 12A, 12B, 12C, assigns at least one of said plurality of software applications to corresponding ones of the plurality of computers 12A, 12B, 12C and assigns at least one of said plurality of computers 12 to a group 14A, 14B, 14C, 14D. The tool performs configuration and system management through, for example, the use of scripts.

The tool monitors and stores a network capacity and an operating-computer performance of the network 10. The operating-computer performance of the network can include one or more of an inoperable state, an unknown state, an in-service state, and a utilization state, for example a percent utilization state. Likewise, the network capacity can include a percent utilization state, for example by measuring a number of images communicated in the network over time, number of tasks completed over time, or number of web-pages served over time. This data is used to fine-tune the system performance by modifying the computer allocations to groups, for example, or alerting operators to problems that are then addressed by modifications to the system. By maintaining the various attributes of the system and loading those attributes into each of the elements in the network (e.g. the computers, groups, and software applications), as elements such as groups are physically added or removed from the system, the tool modifies the database and the system performance accordingly, even while the network, computers, and software applications are running.

Referring to FIG. 2, the database 22 includes a variety of entries, for example an entry for the network an entry for each computer, an entry for each computer type, an entry for each group, and an entry for each software application type. For simplicity, FIG. 2 has only a few examples of each entry type. Those skilled in the art will readily appreciate that the database structure, entries, and attributes can be organized in different ways; FIG. 2 is merely an illustration of one design approach. As illustrated in FIG. 2, the physical elements of the system have physical attributes, including performance metrics, limits, and status (e.g. the network and computers). The computer types have, in addition, possible software application assignments. Each computer has an identifier, hardware attributes, and software attributes as part of a software application assignment. Each group has corresponding computers identified as part of the group and a related software application assignment. Each software application also has attributes and related hardware platforms. These elements listed in the database are not by any means limiting in the sense that many other attributes can be included and can be organized in alternative ways.

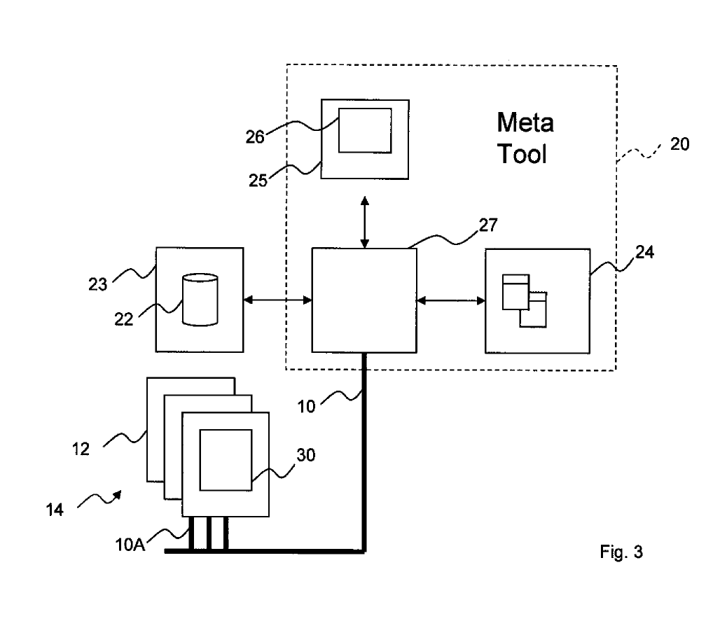

Turning to FIG. 3, the tool is shown in more detail in a preferred embodiment of the present invention. The tool 20 is implemented in a software application running on a computer 27, and implemented in any of a variety of computer languages. The tool employs a user interface 24 to interact with an operator, if necessary, to report status or to accept commands, and includes a connection to the network 10 to control and monitor groups 14 of computers 12 connected with network connections 10A to the network 10. The computers 12 execute software applications 30. A database 22, for example running on a database controller 23 is connected to the tool computer 27, as are storage devices 25 and a set of rules 26 (that can be included in the database 22 or stored in a separate storage medium). The physical or logical division of computing tasks and platforms for the database 22, the database controller 23, the computer 27, the storage device 25 and the rules 26 are arbitrary and can be selected as a matter of design choice. For example, a single computer system having a memory and CPU could be used to implement all of the functions. Alternatively, the elements listed could be implemented on a plurality of computing platforms with various peripherals. Any of these preferred embodiments are considered a part of the present invention.

Referring back to FIG. 1, a tool for managing a heterogeneous computer network comprises a plurality of computers 12 connected to the network 10 through network connections 10A. The computers are organized into groups wherein each group 14A, 14B, 14C, 14D includes one or more of the plurality of computers 12. The computer group assignments are specified by the database and configured by the tool, as shown in FIG. 2. The assignments can be determined by computer attributes. For example, some types of computers can only perform certain function associated with a particular group. Alternatively, the performance of groups of computers can indicate a need for improvements in group performance and a computer added to the group to improve the performance of the group. In another preferred embodiment, the group assignments are made by an operator. In any case, the group assignments should be made to effectively implement the functional goals of the computer network. Each of the plurality of computers 12 has a computer hardware type 12A, 1213, 12C, a corresponding computer identifier, and one or more computer hardware attributes stored in the database, as shown in FIG. 2. A first one of the groups 14A, 14B, 14C, 14D includes computers having computer hardware attributes, software attributes, or computer hardware types different from computers in at least one other of the groups 14.

The computer hardware attributes can include computer type and associated hardware and software attributes that can include one or more of network addresses, group identifiers, operating system images, data partitions on storage devices, and application software. Hardware attributes can include physical performance capabilities such as clock speed, number of processors, hardwired addresses, memory, and storage space. Software attributes can include software applications, operating system types, group assignments, and other programmable features or capabilities.

Network attributes can limit and control interactions over the network and are employed to specify the interactions between system elements. For example, the bandwidth allocation to a computer can be indicated in the database and enforced by a network manager. Network management tools are commercially available. For example, network attributes specify the software interactions of each of the computers with others of the computers in the same group and with others of the computers in other groups. For example, a software application can include a list of servers from which the software application can request information or support. The software application can also include a list of functions that it can request such as e-commerce functions, web-pages, etc. The network attributes also specify hardware and network interactions between computers in each group and with computers in other groups in the computer network. Alternatively, a network attribute can specify the allowed requests or data that one computer or software application can make or provide to another. The attributes are provided to the software applications during configuration by the tool. An attribute is a data element in the database that has an associated meaning when employed to configure the behavior of a computer or software application.

Different layers of configuration, network specification, domain names, internet protocol addresses and ranges, subnets, and zones, operating systems, computer clusters, deployment labels, and quality assurance and performance testing procedures are included. Configuration describes the specific performance and capability choices made for a hardware or software system. The configuration is specified by the database and implemented by the tool when the hardware elements (computers) are initialized and put into service. Likewise, software is configured when it is loaded or operated. The network attributes specify the type of network and communication protocols that are used over the network. Internet addresses and ranges are the means by which specific network elements such as computers specify which other network elements are communicated with over the network. Subnets and zones refer to groups of network elements defined by address groups. Operating systems refer to the fundamental software of a computer and with which a software application interacts to control the user interface, storage, and other computer hardware. Computer clusters are groups of computers that have common or inter-related tasks. Deployment labels refer to task assignments for computers, for example the software applications. Quality assurance and performance testing refer to software-managed testing tools that can test the performance and functionality of a hardware element in the network. Each of these elements can vary in one preferred embodiment or another; the database and tool enforce consistency between system elements (hardware and software) and ensure efficient interactions. For example, some types of operating system are incompatible or error prone in interactions with other operating systems. Likewise, the protocols used by one software application can be inconsistent with the expectations of another application, for example requests to storage systems require a particular protocol that must be provided by a requesting software application. It is particularly important, when upgrading a system, to ensure that the elements are mutually compatible; the rules in the database and enforced by the tool can specify which hardware or software applications are mutually compatible and consistent.

Each computer type 12A, 12B, 12C is preferably configured to optimize a particular type of computing task, for example, serving web pages in response to requests received over the network. Another example is storing, retrieving, and managing image information in a database. A third example is transaction processing such as performing financial transactions. Each computer has one or more attributes that describe the configuration, performance, and interaction options that are particular to the computer and type, for example network address, memory, group identification, performance limits, software application assignment, data storage partitions, and operational state. These attributes can be stored in the database as data elements in a list associated with a system element (hardware or software) and are used as part of a configuration set up to specify the operation of each computer. The tool then uses the data elements to configure the system elements, for example by writing values into particular memory locations in files on the target system.

The computer identifiers are unique and serve to distinguish each computer 12 from all of the other computers 12 in the network 10 and can include a combination of address, type, and attribute so that the identifier also provides information about the computer. The groups are a set of computers of similar type engaged in a common type of task and generally running the same software application. Groups include attributes such as a group identifier, a set of computers, and a software application. Different operating systems can be used for different groups.

The system further includes a plurality of software applications. The software applications can be specific to a system or can be taken from publically available commercial or open source providers. Each of the software applications has a software identifier, each of the software applications execute on computers of one of the groups. Each of the software applications can have one or more software attributes that specify a software interaction for each of the software applications with other ones of the software applications executing on computers within a same group and with other ones of the software applications executing on computers within a different group. For example, software attributes can include the types of software requests for services that are allowed, allowed protocols, and types of information that are managed by the software. Software attributes are typically recorded in data entries in the database and in computers executing desired software applications (e.g. stored in files on a computer hard disk). The data entries can be written into the files by the tool when the software applications are configured, in response to the specification in the database. Software attributes can include operating systems supporting the software, features supported, and interaction modalities or file types.

Three different types of computers (12A, 12B, 12C) are illustrated in FIG. 1. Eight computers of type 12A are divided into two groups 14A and 14B. Three computers of type 12B form a third group 14C, and three computers of type 12C form the fourth group 14D. Although the illustrations are arbitrary, the different computer types could include web-page servers (computer type 12A), database and storage servers (computer type 12B), and financial transaction servers (computer type 12C). The two groups of web-pager servers (14A, 14B) could have different software applications executing on them to meet different needs in the system.

In operation, a variety of tasks provided from an external source, for example web-browsers operated by customers ordering products, for example image-based products. The web-pages are served by a web-page group of computers (e.g. group 14A with computers 12A in FIG. 1). The web-page group of computers interacts with an image storage group (e.g. group 14C with computers 12B in FIG. 1) to provide digital images to the customers for viewing. Actual product orders are mediated through a financial transaction group (e.g. group 14D with computers 12C in FIG. 1) to provide financial services, such as credit card services, to the customers.

As long as the status quo is maintained and meets the customers' needs, the tool need take no action with regard to the operation of the elements in the network. The tool gathers performance information with respect to the network (e.g. images communicated from the various computers and groups) and monitors the performance of the network, groups, and computers. If the performance of the system changes in some way, the tool can transmit a notification in response to detecting the change to an operator or automatically instantiate corrective action. For example, the operating-computer performance or the network capacity utilization can reach pre-determined limits (possibly specified in the rules database). The tool allows an operator to dynamically add a computer to the network, remove a computer from the network, or repurpose a computer in the network by modifying the database while at least one of the computers currently connected to the network is executing one of the software applications. The database can be modified by adding an entry, removing and entry, or editing one or more entries in the database.

For example, if order volume increases and system performance decreases unacceptably, the tool alerts the operators of the system to the situation through a notification and the operators decide to invest in additional computing resources; the decision is driven by the monitored performance and includes, for example, additional storage, additional computers, changes in software, etc. In one example, the operators choose to increase storage. Additional storage (e.g. for group 12B) is then physically connected to the network. At this point, an operator interacts as necessary with the tool user interface to specify the addition of the additional storage computer, the network address, disk partitions, software application, and so forth. The tool restricts the choices provided to, and selected by, the operator, to be consistent with the rules in the database. For example, the additional storage computer may not be capable of executing financial transaction software. Hence, once the computer type is identified (either by the operator or automatically by the tool through the network) only suitable software applications are allowed and loaded.

When the desired and possible attributes of the additional computer are specified, the tool configures the additional computer with the corresponding information and enters the additional computer and data into the database, including the group and software assignments. The additional computer then begins operation.

A similar process is employed when a computer is taken out of service. If an operator decides that a particular function is over-served and that better use could be made of a computer in a group assigned to an over-served task, the operator interacts with the tool to remove the database entry corresponding to the removed computer and the computer removed. These additions or removals of computers are done while the system is running, since the modified hardware is not physically tied to the other operational elements of the system, except through the network.

When physical hardware changes are not necessary, the tool can automatically reconfigure the system with, or without, operator intervention, so that, for example, the tool automatically reassigns a computer from one group to another group by modifying the corresponding database entries in response to the operating-computer performance or the network capacity reaching pre-determined limits while at least one of the computers currently connected to the network are executing one of the software applications. The pre-determined limit of the computers in the other group indicates excess load or the pre-determined limit of the computers in the one group indicates excess capacity or capacity utilization. If, for example, a group of computers has excess capacity (i.e. the group is underutilized) and another group of computers that can run the same software application or that can be reconfigured to run the same software application is excessively loaded with tasks that are not met in a desired timely fashion (i.e. the other group is overloaded), the tool automatically detects this condition (for example, by using capacity utilization measurement tools or process monitoring tools that are known in the art) and automatically reassigns a computer in the excess-capacity group to the excess-load group by modifying the database entry and reloading the necessary attributes and software into the reassigned computer. The reassigned computer is reconfigured as necessary to enable the reassigned computer to execute the tasks of the excess load group. In contrast to prior art load balancing methods in which tasks are reassigned from one group to another, according to a preferred embodiment of the present invention, one or more computers are reassigned from one group to another group and the reassignment requires a reconfiguration change in the reassigned computer. The reconfiguration change can be a change in software application or in some other hardware or software attribute of the reassigned computer. In particular, in one preferred embodiment of the present invention, a method of managing a network comprises assigning a plurality of processors to a plurality of network connected computing groups. Each processor in an assigned computing group receives task types over the network that are different from task types received over the network by processors assigned to any other computing group. A workload of each of the computing groups is monitored, including programmably setting an upper threshold and a lower threshold for each of the plurality of computing groups.

A workload is detected in a first one of the computing groups that is equal to or higher than its set upper threshold, including detecting that a workload of a second one of the computing groups is equal to or lower than its set lower threshold. A processor is reassigned from the second computing group to the first computing group in response to detecting the workload imbalance.

In a typical reassignment process, the computer to be reassigned is initially executing processes corresponding to the group of which it is a member. No further tasks are assigned to the processor to be reassigned until all of the processors pending tasks are completed. The computer can then be shut down or otherwise idled and new software or other reconfiguration steps completed including the modification of the database that describes the assignment of computers to groups. Once the computer is reassigned it can be given tasks according to its new group assignment.

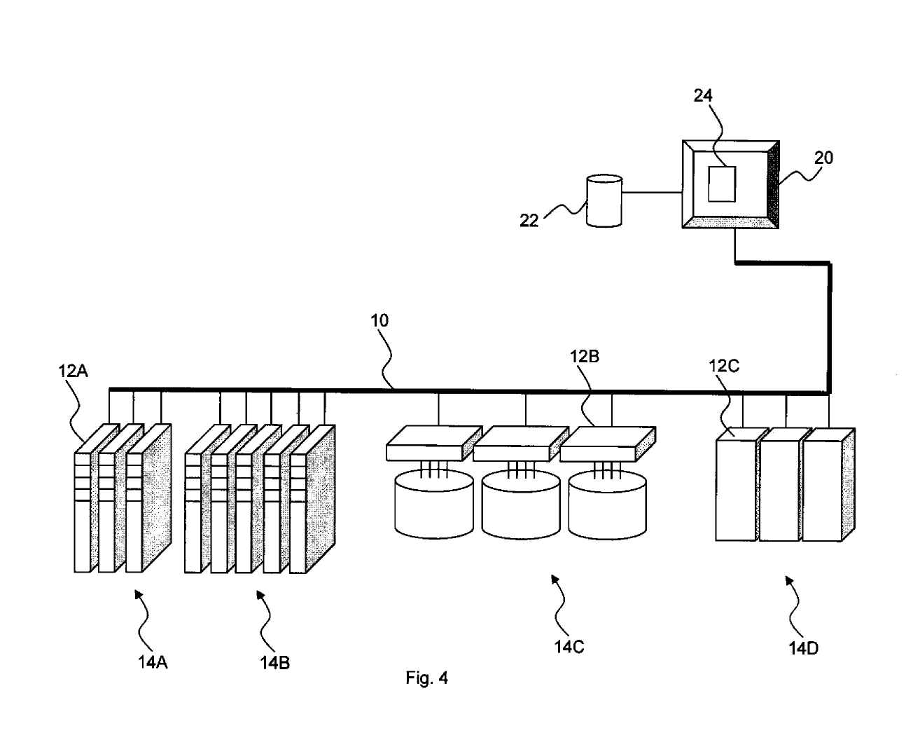

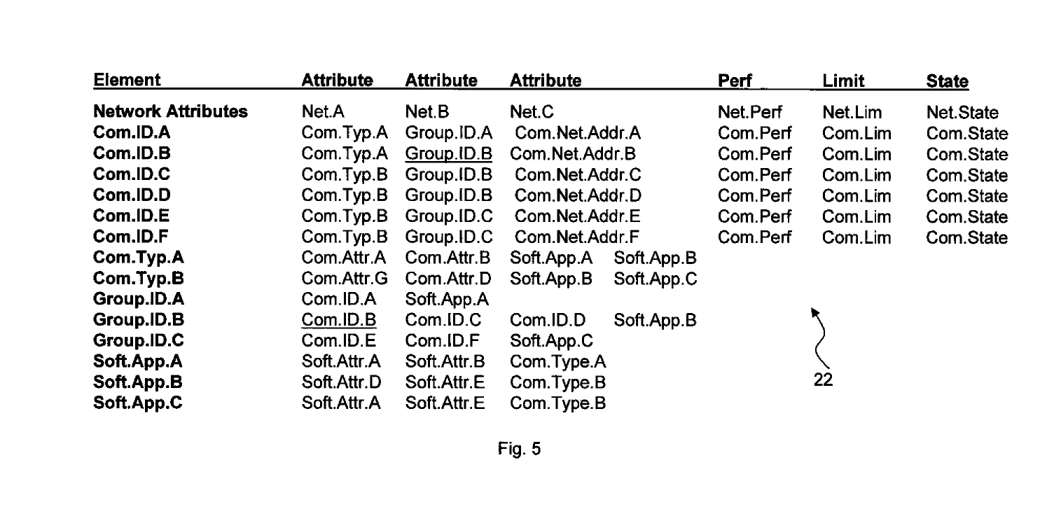

Referring to FIG. 4, in contrast to FIG. 1, a computer 12A in group 14A has been reassigned to group 14B, illustrated by drawing the reassigned computer as part of group 14B. FIG. 5 illustrates a complementary change in the database of FIG. 2 (not all of the elements in FIGS. 1 and 4 are found in the Tables). As shown in the database FIGS. 2 and 5, computers of type A operates software applications A and B. As shown in FIG. 2, the computer with computer identification B (“Com.ID.B”) operates as part of the computer group A (“Group.ID.A) and thus executes software application A (“Soft.App.A”) as part of group A (“Group.ID.A”). After the reassignment is complete, as shown in FIG. 5, the reassigned computer (“Com.ID.B”) now has the attribute of group B (“Group.ID.B” indicated by underlining), is included in Group.ID.B, and executes software application B (“Soft.App.B”). Since the reassigned computer has a type that permits the execution of software application B, the reassignment is allowed by the rules inherent in the database and the reassignment is permitted.

In another useful preferred embodiment, the tool monitors the status of the various computers, including run-time errors and network errors. If a computer is experiencing difficulty for some reason, the tool automatically removes the computer from service by modifying the database and/or interacting directly with the computer to change its state. The errant computer could be automatically restarted or reconfigured by the tool without necessarily requiring operator interaction. The tool is also used to audit the computers on the system, checking for consistency between the database and the actual deployed hardware.

The tool database includes both rules governing hardware and software assignments and the assignments themselves, while the tool employs the database to ascertain and control and monitor the actual hardware system. Thus the system changes dynamically, in some cases automatically, during operation, with little possibility of error and little effort on the part of an operator, providing a productive and flexible system.

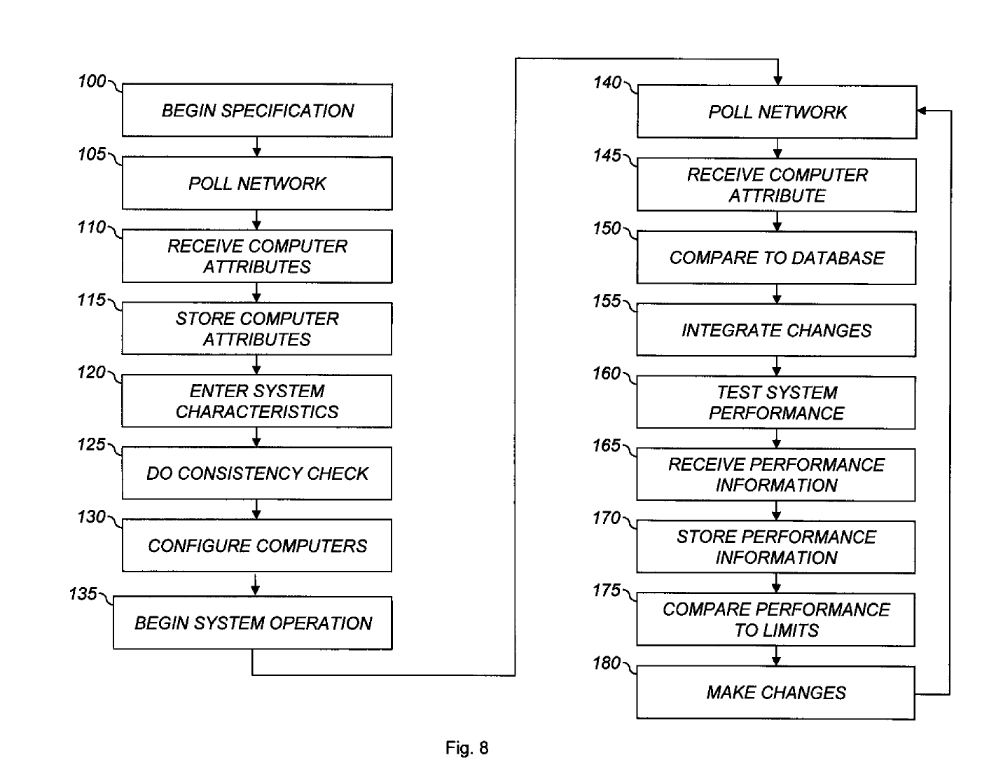

Referring back to FIG. 3, in an illustrative operational example, a computer 27 on the network executes the tool 20 software including the operator user interface 24, storage device 25, and database controller 23. The software accesses the rules 26, the database 22, and interacts over the network 10 with the other computers 12 and software applications 30. Referring to FIG. 8, in an example of a start up process that initializes the system, the tool begins specification in step 100. The tool polls the network in step 105 receiving from the network-connected computers information specifying the computers, hardware attributes, and software loaded in the computers in step 110. The information is stored in the database in step 115 and corresponds to the Com.ID entries in the database shown in FIG. 2.

A system manager interacts through the user interface to define the desired system operating characteristics in step 120. The information defining the computer types, attributes, allowed software applications, and limits for the computer types can be stored in the Com.Typ entries. The information organizing the computers into groups can be entered as the Group.ID entries; the system manager thus specifies the number of groups (by the number of entries) and the desired assignment of computers to the group, and also defines what software is to operate on computers in the group. Software attributes can likewise be specified (Soft. App entries) and network information (Network Attributes). Some of the attribute entries can be provided by the polled information from the computers themselves, for example hardware characteristics such as memory and storage.

The system manager can also define the system performance thresholds (Limit column) for the different hardware elements.

Once the system manager information is entered, the tool can perform a consistency test (step 125) to ensure that the computers on the network correspond to the database specification. For example, the tool can test the database entries to ensure that every computer is assigned to a group, that every computer type found is in the database, and that the correct software is loaded into the computers, for example corresponding to the information in the Group.ID entries. Any anomalies can be brought to the attention of the system manager through the user interface for correction or corrected automatically. Once corrected, the computers can be loaded with the appropriate software (if not already done) and configured according to the specification in the database (Soft.App entries) in step 130.

To this point, the system and its desired operation are being specified and configured. Once correctly specified, the system can be put into operation in step 135. Once in operation, the tool periodically polls the network (step 140) receives the computer attributes and identifiers (step 145), and compares the database information with the network information 150. Any discrepancies found indicate a change in the system. Any change can be integrated into the system in step 155. A variety of exemplary changes are discussed below.

At the same time as, before, or after, the network polling step 140, the tool can test the system performance in step 160 and receives system performance information (step 165). This can be done by observing network traffic (packets) and by interacting with the computers and software applications executing on the network (e.g. tasks done per second, data transfers per second, queue lengths, etc.). This information can also be used to specify the state of the computer (State column in FIG. 2), e.g. operational, no load, light load, heavy load, or percent load. The load represents a utilization rate or status. In an extreme case, a defunct computer may not respond, in which case the state can be assigned as “defunct”. The performance information is stored in step 170. Once determined, the performance can be compared to performance limits specified in the database (step 175). If any performance limits are exceeded, the tool makes changes or alerts the system manager, as appropriate and specified in the rules or tool software (step 180). A variety of exemplary changes are discussed below.

The tool then repeats the polling and performance monitoring tasks. The tool can also respond to interruptions from the user interface, for example prompted by the system manager (not shown in FIG. 8) and make any changes requested.

To this point, the tool, with system manager input, has specified the system and its desired operating parameters and attributes and stored the specification in the database. The tool also monitors the operation and performance of the system, recording the information in the database. If no changes in the system hardware are seen or the performance of the system matches the specified levels, no further action is undertaken by the tool. However, the tool is most useful in automating desired changes in the system due to operational needs.

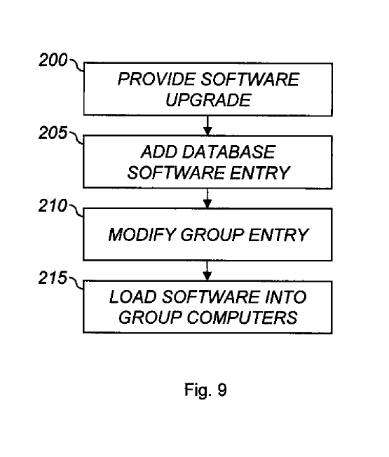

Referring to FIG. 9, one simple and relatively commonplace change is providing an upgrade in a software application for a computing element in the system (step 200). This can be accomplished, without taking the system down, by interacting with the tool to add an entry in the database (step 205) corresponding to a software application (Soft. App in FIG. 2), including any attributes associated with the software application and specifying which computer types can operate the software application. The group of computers that are intended to run the software application is specified by modifying the group attributes (Group.ID in FIG. 2) to specify the new software application in step 210. The tool can then load the new software into all of the computers in the group, and the system continues to operate. While an individual computer may be inoperable during the load process, the remaining computers in the group and in the system continue to operate, thus keeping the system running.

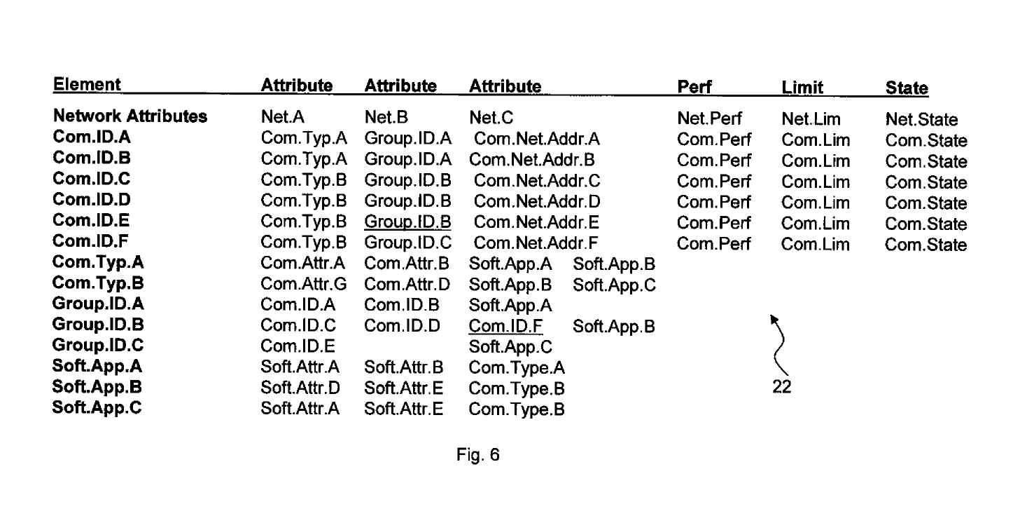

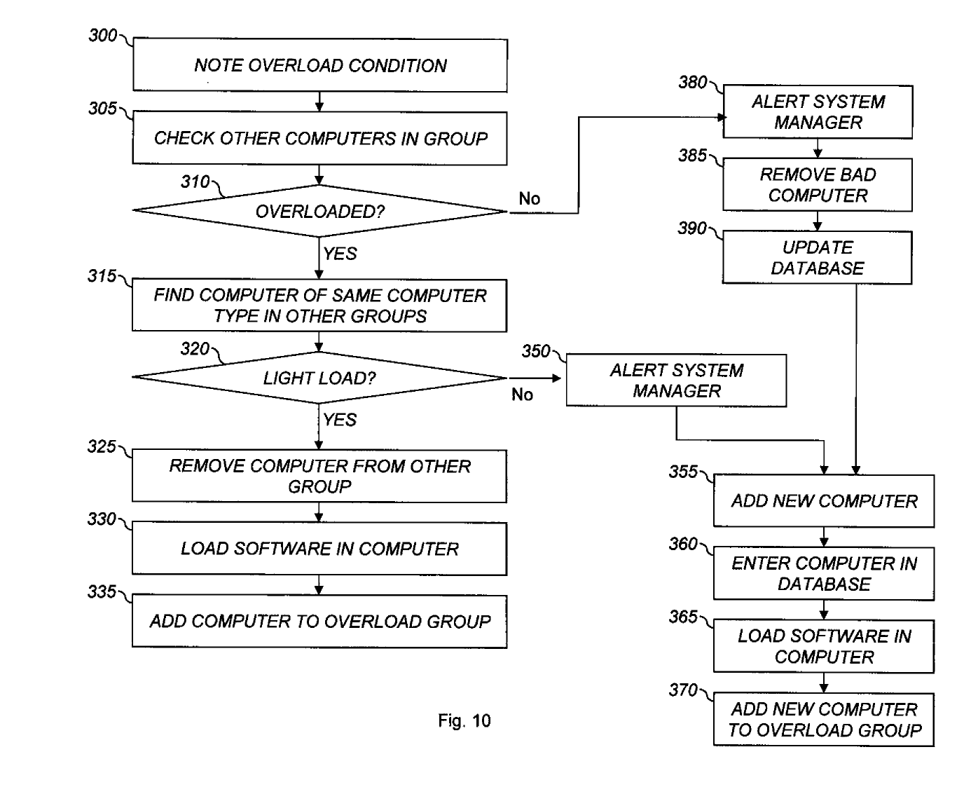

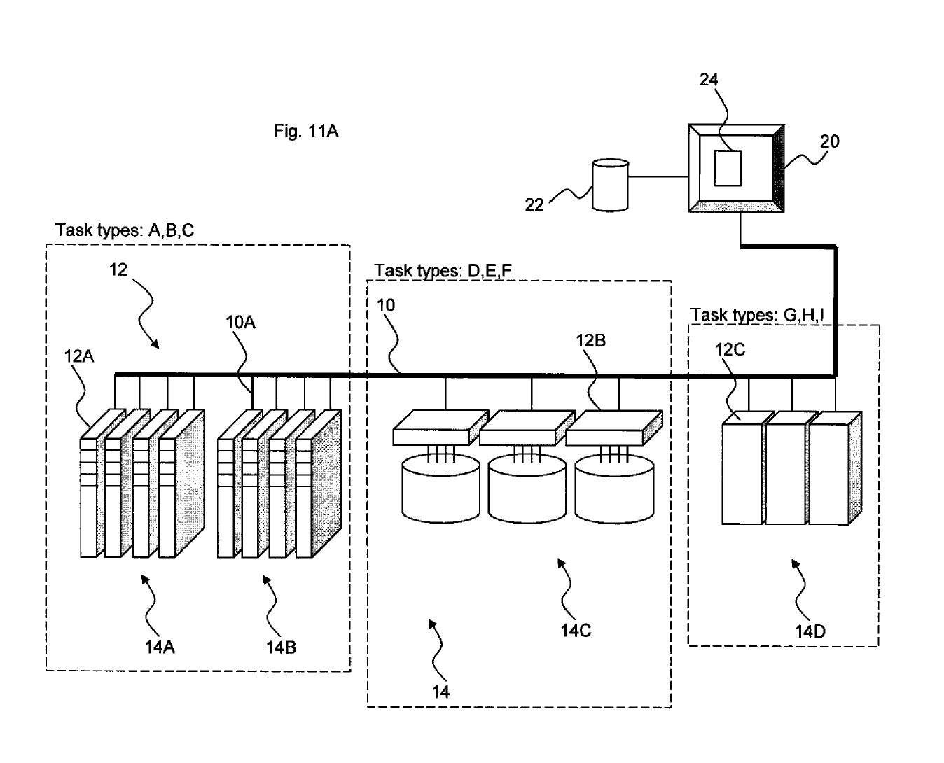

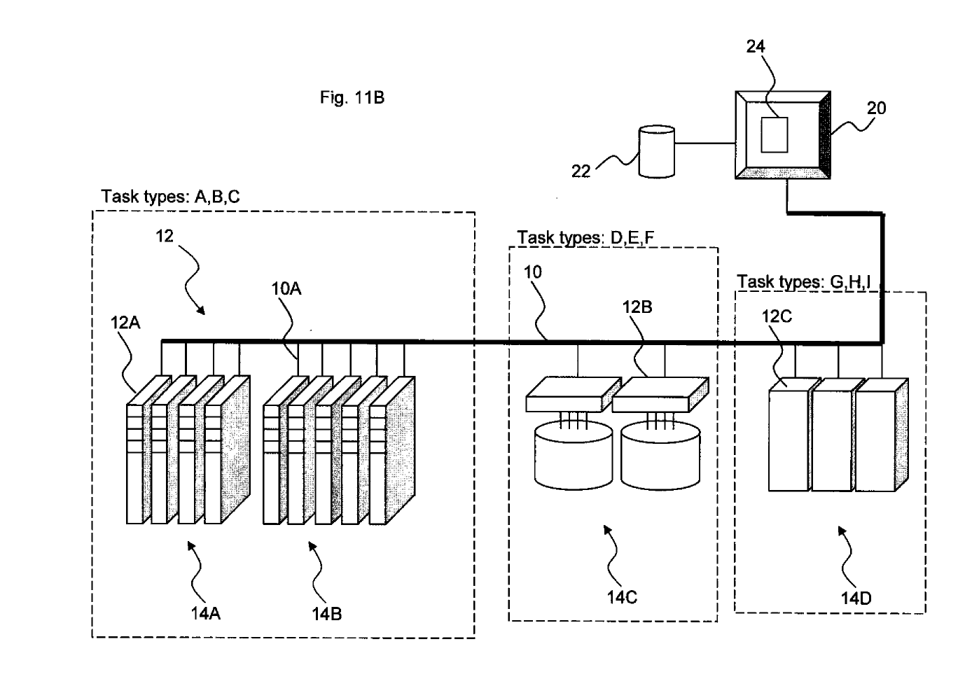

The tool can automatically adjust the system to compensate for changes in load. As discussed above, the tool periodically updates the database to record current performance and then compares the performance to limits specified by the system manager in the database (step 175, FIG. 8) and makes changes if a limit is reached (step 180 FIG. 8). Referring to FIG. 10 in an example, a computer can be overloaded and the condition is stored in the database (State column of FIG. 2). The tool notes the overload condition in step 300 (corresponding to step 175 of FIG. 6). Note that it is likely that all of the other computers in the group are similarly overloaded. This condition is tested in step 305 by examining the computer state (col. State in FIG. 2) for each computer (Com.ID) found in the group list having the overloaded computer (Group.ID). If the other computers in the group are similarly loaded (“Yes”), then an additional computer needs to be added to the group. If that is not the case, then the overloaded computer may be faulty and should be replaced (“No”). The tool then checks the database for other groups having computers that can support the same software as the overloaded computer. This information is found by checking the computer type of the overloaded computer (Com.ID), checking the corresponding software applications supported by the computer type (Com.Typ), and finding a group having computers that can run the software application of the overloaded computer.

For example, referring to the example database of FIG. 2, if Com.ID.C is overloaded, as is Com.ID.D in the same group (Group.ID.B), the tool finds that Com.ID.C is a member of Group.ID.B which executes Soft.App.B. In examining the Soft.App.B entry of the database, it is found that Com.Typ.B executes Soft.App.B. Also, Com.ID.C is of type Com.Typ.B. Therefore, any computer in a group that uses Com.Typ.B could be considered for Group.ID.B. Further examining the software application entries, it is noted that Soft.App.C can be executed on Com.Typ.B and that Group.ID.C executes Soft.App.C and uses computers of type Com.Typ.B. Therefore, a computer can be removed from Group.ID.C, loaded with Soft.App.B, moved to Group.ID.B, and put into service.

In an alternative approach, all of the computers in the network can be checked. Those that are of the same type and are in a different group are candidates for reassignment. Reviewing the example database of FIG. 2, the tool can find that Com.ID.E and Com.ID.F are of the same type (Com.Typ.B) as the overloaded computer Com.ID.C and are members of a different group (Group.ID.C) than the overloaded computer Com.ID.C (Group.ID.B).

Once computers that can be added to the overloaded group are identified (step 305), they are tested to see if they have a lighter load than the overloaded computer in step 310. In this example, Com.ID.E is presumed to be lightly loaded. Com.ID.E is therefore removed from Group.ID.B by removing the identifier from the Group.ID.B entry in step 325. Com.ID.E is then loaded with Soft.App.B (replacing Soft.App.C) in step 330 and added to Group.ID.B by adding the identifier Com.ID.E to the entry Group.ID.B in step 335. The corresponding change is made to the Com.ID.E entry indicating the group assignment. The changes are shown underlined in FIG. 6.

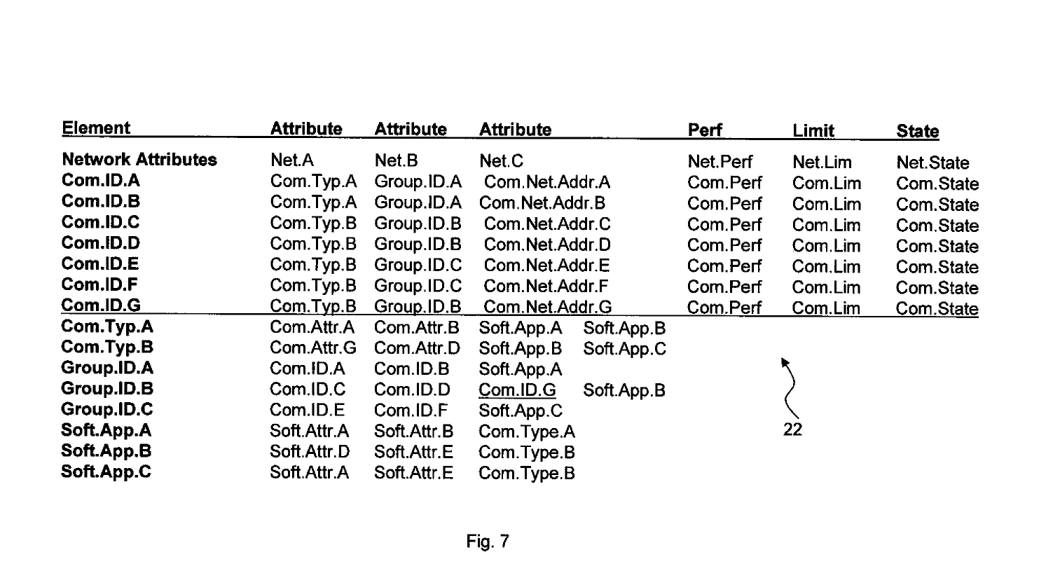

If Com.ID.E (and Com.ID.F) are not lightly loaded, then a computer cannot be reallocated from Group.ID.C to Group.ID.B. In this case additional computing resources are needed. The tool can alert the system manager through the user interface (step 350). The system manager can then physically add a new computer of type Com.Typ.B to the network by connecting a computer to the network (step 355). The tool will detect the new computer (and type if the hardware type is automatically known; otherwise the system manager must enter the information) and add it to the database (step 360) as Com.ID.G and to the group entry (Group.ID.B) as shown in FIG. 7. The corresponding group software application (Soft.App.B) is loaded into the new computer Com.ID.G in step 365 and the computer added to the overloaded group (step 370).

If the different computers within the group are not uniformly overloaded, it is possible that the overloaded computer has a fault and can be removed from the system. In this case, the tool can alert the system manager (in step 380) to remove the bad computer (step 385) and remove the corresponding entries from the database (Com.ID.C and the reference in the group Group.ID.B). A new computer can then be added as described above. The resulting database will be the same as FIG. 2, except that Com.ID.C can be replaced by Com.ID.G.

The only steps in these processes that are not automated are the system manager alerts and the physical removal and addition of computers to the network. Hence, the present invention can manage the system without intervention in many cases, providing not only load balancing, but computer reassignment to new functional tasks requiring different software applications, and automated configuration of system elements in response to changes in the system use.

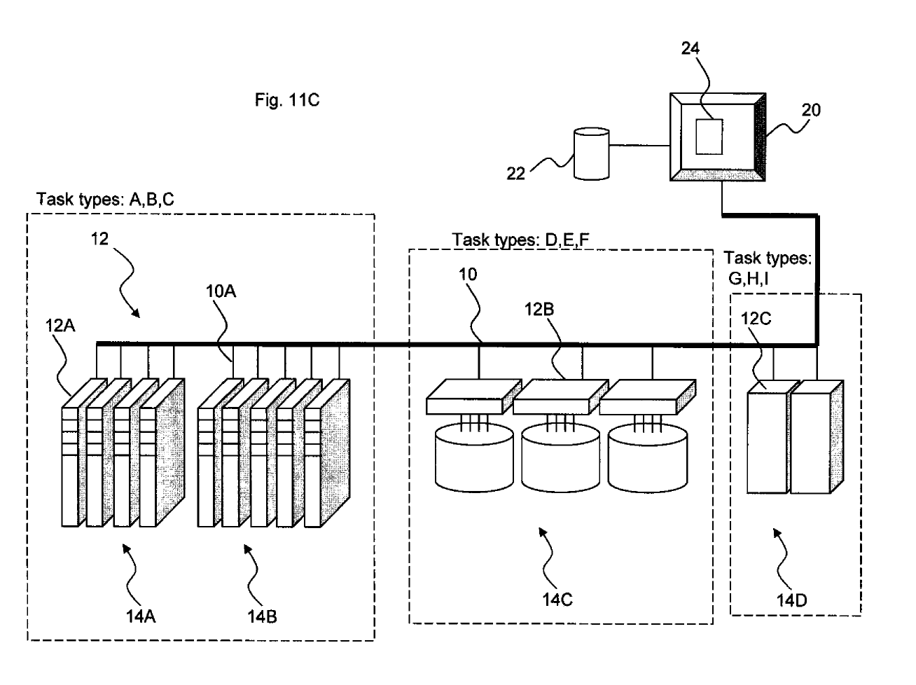

With reference to FIGS. 11A-C, another preferred embodiment of the present invention will now be described. Computers in computing groups 14A-14B, 14C, and 14D are assigned to process task types A-B-C, D-E-F, and G-H-I, respectively. This example is not meant to demonstrate any limitations as far as number of task types or combination of task types or number or type of processors or computing groups, and it will be understood that any feasible and compatible combination of processors, processing groups, and task types can be implemented. Task type and computer group assignments are stored in database 22 and, in response thereto, are issued by controller 20 over the network 10 to assigned computer groups. A network workload monitor programmed at 20 detects ongoing workloads of each the computing groups. When two conditions are met, the network controller begins a reassignment procedure for reassigning computer resources (e.g. a processor) from one computing group to another. The first condition, to be detected by the workload monitor, is that one of the computing groups meets or exceeds a preprogrammed upper workload threshold. The second condition is that another one of the computing groups is operating at or below a lower workload threshold. When these conditions are satisfied, it will trigger the network controller at 20 to begin a shutdown procedure, described below, for at least one of the processors in the computing group that is operating at or below the lower workload threshold. After the shutdown, or idling, of the processor is complete, it will be reassigned to the computing group that has reached or exceeded its upper threshold. Thereafter, the reassigned processor will begin receiving task types assigned to its new computing group from the controller over network 10, thereby reducing the workload on the computing group to a level below its upper threshold. As shown in FIG. 11A, a computing group composed of processors 10A and 12A is undergoing a high workload event during processing of any combination of task types A, B, C which meets or exceeds its programmed upper threshold while computing group 14C is detected by the network monitor to be operating at or below its lower threshold during processing of any combination of task types D,E,F. FIG. 11B illustrates a configuration of the network after a processor is reassigned, following the procedure described above, from computing group 14C to 14B. At a later time, its possible that computing group 14C reaches its upper workload threshold while processing some combination of task types D, E, F, and that computing group 14D is detected to be operating at or below its lower threshold during processing of any combination of task types G, H, I. After performing a similar reassignment procedure as before, the network configuration is adjusted as shown in FIG. 11C, wherein a processor from computing group 14D is reassigned to computing group 14C and begins receiving any of processing task types D, E, F from the network controller. The reassignment procedures explained above can be undertaken whenever the programmed workload criteria are detected in the network.

In one preferred embodiment of the present invention, task types are shared by multiple groups (e.g. as shown with task types A, B, C for groups 14A and 14B in FIG. 11A). In another preferred embodiment, task types are unique to a group (e.g. as shown with task types E, E, F for group 14C and task types G, H, I for group 14D). Computers within groups can have similar hardware, hardware configurations, software, software configurations and applications. A processor can be reassigned from one group to another to accommodate changes in work load, as discussed above. According to a preferred embodiment of the present invention however, processors that are reassigned from one group to another are also reconfigured so that the hardware attributes, software, software configurations and applications are changed. In particular, different software applications, memory, and storage configurations can be employed between different groups and a computer reassigned from one group to another as a consequence of a variable workload and variable quantities of different task types has its configuration changed from one configuration to a different configuration. Hence, to reassign a computer, its pending tasks are first completed, the computer is reconfigured and reassigned to a different group, and then new, different tasks are assigned to the reconfigured computer.

In summary, in a preferred embodiment of the present invention, the tool controls a behavior of the network, controls a number and type of the groups, controls a number and type of computers within a group, maintains a list of computers, computer identifiers, computer states, and computer histories, and adds and removes computers from the network while at least one of the computers currently connected to the network is executing one of said software applications and the network is operating. This provides a mechanism, for either automatically or with limited operator involvement, to dynamically manage a system dedicated to supporting a single enterprise operated, for example, through web-pages on the internet. Furthermore, the present invention provides a simple way to integrate new or modified hardware capabilities into a network and to add new or modified software applications, patches, new releases, updates, and the like.

Database software, web-page servers, digital data storage systems, computer networks, and financial transaction software and hardware are all known in the art.

The present invention is employed to support businesses conducted over the internet, in particular businesses that employ large amounts of digital storage, such as image printing.

The invention has been described in detail with particular reference to certain preferred embodiments thereof, but it will be understood that variations and modifications can be effected within the spirit and scope of the invention.

### PARTS LIST

10 network
10A network connection
12 computers
12A computer type A
12B computer type B
12C computer type C
14 groups
14A group A
14B group B
14C group C
14C group D
20 tool
22 database
23 database controller
24 operator user interface
25 storage device
26 rules
27 tool computer
30 software application
100 begin specification step
105 poll network step
110 receive computer attributes step
115 store computer attributes step
120 enter system characteristics step
125 do consistency check
130 configure computers step
135 begin system operation step
140 poll network step
145 receive computer attribute step
150 compare to database step
155 integrate changes step
160 test system performance step
165 receive performance information step
170 store performance information step
175 compare performance to limits step
180 make changes step
200 provide software upgrade step
205 add database software entry step
210 modify group entry step
215 load software into group computers step
300 note overload condition step
305 check other computers in group step
310 overload? decision step
315 find computer of same computer type in other groups step
320 light load? decision step
325 remove computer from other group step
330 load software in computer step
335 add computer to overload group step
350 alert system manager step
355 add new computer step
360 enter computer in database step
365 load software in computer step
370 add new computer to group step
380 alert system manager step
385 remove bad computer step
390 update database step

1. A network comprising:
a plurality of processors each assigned to one of a plurality of computing groups;
a network monitor for detecting a workload of each of the plurality of computing groups;
a network controller responsive to the network monitor for reassigning a processor from a first computing group that is detected by the monitor to be performing below a first preselected threshold to a second computing group that is detected by the monitor to be performing above a second preselected threshold, wherein the reassigned processor processes tasks in the second computing group that are of a different type than the tasks performed by processor in the first computing group.

2. The network of claim 1, wherein the controller transmits a notification over the network in response to detecting that the second computing group is performing above the second preselected threshold.

3. The network of claim 1, wherein the network monitor includes means for detecting a performance characteristic selected from the group consisting of an inoperable state, an unknown state, an in-service state, and a percent utilization state.

4. The network of claim 1, wherein the first and second preselected thresholds include a percent utilization rate.

5. The network of claim 1, wherein the first and second preselected thresholds include a rate of images communicated in the network.

6. The network of claim 1 further comprising a database identifying software applications associated with particular ones of the computing groups wherein the software applications are executable only by a processor in an associated computing group.

7. The network of claim 6, wherein the database comprises a list of computer hardware types associated with each of the software applications.

8. The network of claim 1, wherein a reassignment of a processor includes a shut down procedure wherein new tasks are not assigned to the processor undergoing reassignment.

9. The network of claim 6 further comprising network attributes stored in the database that specify allowable interactions of the software applications between processors in any of the computing groups.

10. A method of managing a network comprising:
assigning a plurality of processors to a plurality of network connected computing groups, wherein each processor in an assigned computing group receives task types over the network that are different from task types received over the network by processors assigned to any other computing group;
monitoring a workload of each of the computing groups, including programmable setting an upper threshold and a lower threshold for each of the plurality of computing groups;
detecting that a workload of a first one of the computing groups is equal to or higher than its set upper threshold, including detecting that a workload of a second one of the computing groups is equal to or lower than its set lower threshold; and
reassigning a processor from the second computing group to the first computing group in response to the step of detecting.

11. The method of claim 11, further comprising the step of transmitting a notification over the network in response to detecting that a workload of the first one of the computing groups is higher than its set upper threshold.

12. The method of claim 11, further comprising the step of detecting a performance characteristic of the first one of the computing groups wherein the performance characteristic is selected from the group consisting of an inoperable state, an unknown state, an in-service state, and a percent utilization state.

13. The method of claim 11, further comprising the step of detecting a percent utilization rate of the first one of the computing groups and of the second one of the computing groups.

14. The method of claim 11, further comprising the step of detecting a rate of images communicated in the network.

15. The method of claim 11 further comprising the step of storing in a database identifications of software applications associated with the first or second computing groups.

16. The method of claim 15 further comprising the step of storing in a database identifications of hardware types associated with the first or second computing groups.

17. The method of claim 11, further comprising the step of initiating a shut down procedure for the processor being reassigned from the second computing group to the first computing group.

18. The method of claim 17, wherein the shutdown procedure comprises the step of not assigning new tasks to the processor being reassigned from the second computing group to the first computing group.

19. The method of claim 18, wherein the shutdown procedure comprises the step of reassigning the processor to the first computing group after the reassigned processor reaches an idle state.
